(19) United States
(12) Patent Application Publication
(10) Pub. No.: US 2026/0320992 A1
(43) Pub. Date: Oct. 15, 2026

(54) IMAGING DEVICE, IMAGING SYSTEM, AND IMAGING DEVICE CONTROL METHOD

(71) Applicant: SONY SEMICONDUCTOR SOLUTIONS CORPORATION, KANAGAWA (JP)

(72) Inventor: SUSUMU HOGYOKU, KANAGAWA (JP)

(21) Appl. No.: 19/485,224

(22) PCT Filed: Apr. 3, 2024
(86) PCT No.: PCT/JP2024/013809

§ 371 Date: Nov. 17, 2025

(30) Foreign Application Priority Data
May 29, 2023 (JP) 2023-087403

(51) Int. Cl. G06V 10/82; H04N 23/12

(52) U.S. Cl. CPC G06V 10/82; H04N 23/12

(57) ABSTRACT

To suppress performance degradation when sparsity is improved in an imaging device using a neural network. The imaging device includes a predetermined number of output-side neurons and a statistic calculation unit. In this imaging device, each of the output-side neurons generates an output signal on the basis of an input signal from an intermediate layer every time a predetermined unit time elapses. The statistic calculation unit performs, for each output-side neuron, a calculation of a statistic of the output signals generated within a predetermined frame period longer than the unit time.

### TECHNICAL FIELD

The present technology relates to an imaging device. Specifically, the present technology relates to an imaging device having a neural network structure, an imaging system, and an imaging device control method.

### BACKGROUND ART

In the related art, an imaging device that dynamically switches modes has been used in various fields such as crime prevention and traffic. For example, an imaging device that images a low-resolution image in a feature detection mode to detect a feature of a subject, and shifts to an imaging mode to image a high-resolution image when a specific feature is detected has been proposed (for example, see PTL 1).

### CITATION LIST

### Patent Literature

[PTL 1] JP 2021-150814 A

### SUMMARY OF INVENTION

### Technical Problem

In the above-described related art, by imaging the low-resolution image until the specific feature is detected, power consumption is intended to be reduced as compared with a case where a high-resolution image is always imaged. However, when a neural network such as a spiking neural network (SNN) is used for feature detection, there is a problem that performance is degraded as sparsity of the neuron is improved.

The present technology has been made in view of such a circumstance, and in an imaging device using the neural network, it is an object to suppress performance degradation when the sparsity is improved.

### Solution to Problem

The present technology has been made to solve the above-described problem, and a first aspect thereof is an imaging device including a simple detector that includes a predetermined number of output-side neurons each of which generates an output signal on the basis of an input signal from an intermediate layer every time a predetermined unit time elapses, and a statistic calculation unit that performs, for each of the output-side neurons, a calculation of a statistic of the output signals generated within a predetermined frame period longer than the unit time, and a control method of the imaging device. This brings about an effect that performance degradation when sparsity is improved is suppressed.

In addition, in the first aspect, a function calculation unit that outputs a calculation value obtained by inputting each of the statistics to a predetermined function may be further included. This brings about an effect that the calculation value is output as a detection result.

In addition, in the first aspect, a control unit that controls a length of the frame period in accordance with a detection result of the simple detector may be further included. This brings about an effect that an appropriate frame period is set.

In addition, in the first aspect, a control unit that controls a threshold value of a neuron in the simple detector in accordance with the detection result of the simple detector may be further included. This brings about an effect that a neuron firing rate is controlled.

In addition, in the first aspect, an image sensor that generates image data may be further included, and the simple detector may detect a predetermined detection target from the image data by analysis. This brings about an effect that the detection target is detected.

In addition, in the first aspect, a detail detector that detects a predetermined detection target from the image data by a more detailed analysis than the simple detector, an evaluator that generates an evaluation value from the image data by an analysis different from the analysis by the detail detector, and a rule selection unit that selects a rule for controlling operations of the detail detector and the evaluator, on the basis of a detection result of the simple detector, may be further included. This brings about an effect that the rule is selected based on the detection result.

In addition, in the first aspect, the simple detector and the detail detector may be disposed in a neural network circuit. This brings about an effect that the number of circuits outside the neural network circuit is reduced.

In addition, in the first aspect, the simple detector, the detail detector, and the evaluator may be disposed in the neural network circuit. This brings about an effect that the number of circuits outside the neural network circuit is reduced.

In addition, in the first aspect, an input control unit that controls an operation of the image sensor on the basis of the detection result of the simple detector may be further included. This brings about an effect that a processing amount of the simple detector is reduced.

In addition, in the first aspect, an environmental sensor that outputs a sensor signal different from the image data may be further included, and the rule selection unit may select the rule on the basis of the sensor signal and the detection result of the simple detector. This brings about an effect that robustness is improved.

In addition, in the first aspect, the simple detector may be disposed in an image sensor that generates image data. This brings about an effect that the number of circuits outside the image sensor is reduced.

In addition, in the first aspect, the neuron in the simple detector may be a spiking neuron. This brings about an effect that information can be made sparse in both time and space.

Further, a second aspect of the present technology is an imaging device including a difference calculator that performs a calculation of a difference between an additional value of a predetermined number of input signals and a feedback signal, an integrator that integrates the difference and outputs an integral value, a limiter that outputs the integral value as an output signal when the integral value is out of a predetermined range, a comparator that compares the output signal with a predetermined value and supplies a comparison result, and a feedback unit that converts the comparison result into the feedback signal and feeds back the feedback signal, in which the difference calculator, the integrator, the limiter, the comparator, and the feedback unit are disposed in at least one of a plurality of neurons in a neural network. This brings about an effect that performance degradation when sparsity is improved is suppressed.

Further, a third aspect of the present technology is an imaging system including a simple detector including a predetermined number of output-side neurons each of which generates an output signal on the basis of an input signal from an intermediate layer every time a predetermined unit time elapses, and a statistic calculation unit that performs, for each of the output-side neurons, a calculation of a statistic of the output signals generated within a predetermined frame period longer than the unit time, and an analysis device that analyzes an image on the basis of a detection result of the simple detector. This brings about an effect that performance degradation of a system when sparsity is improved is suppressed.

### BRIEF DESCRIPTION OF DRAWINGS

FIG. 1 is a block diagram illustrating a configuration example of an imaging device according to a first embodiment of the present technology.

FIG. 2 is a block diagram of an imaging device in a case where a plurality of imaging sections are disposed in the first embodiment of the present technology.

FIG. 3 is a block diagram of an imaging device in a case where circuits other than an image sensor are disposed in a processor in the first embodiment of the present technology.

FIG. 4 is a block diagram illustrating a configuration example of an SNN circuit and a router according to the first embodiment of the present technology.

FIG. 5 is a block diagram illustrating a configuration example of a core according to the first embodiment of the present technology.

FIG. 6 is views illustrating an example of a neural network structure of a simple detector according to the first embodiment of the present technology.

FIG. 7 is a block diagram illustrating a configuration example of a ΔΣ neuron according to the first embodiment of the present technology.

FIG. 8 is diagrams illustrating examples of an input signal and an output signal of the ΔΣ neuron according to the first embodiment of the present technology.

FIG. 9 is a block diagram illustrating a configuration example of a ΔΣ neuron according to a first comparative example of the present technology.

FIG. 10 is graphs showing examples of waveforms of output signals and comparison results when sine waves are input in the first comparative example and the first embodiment of the present technology.

FIG. 11 is graphs showing examples of waveforms of output signals and comparison results when a sparse signal is input in the first comparative example and the first embodiment of the present technology.

FIG. 12 is graphs showing examples of waveforms of output signals and comparison results when a stationary signal is input in the first comparative example and the first embodiment of the present technology.

FIG. 13 is block diagrams illustrating configuration examples of simple detectors according to the first embodiment of the present technology and a second comparative example.

FIG. 14 is diagrams each showing an example of output values of output-side neurons according to the first embodiment of the present technology.

FIG. 15 is a diagram showing an example of an output format according to the second comparative example.

FIG. 16 is a diagram showing an example of an output format according to the first embodiment of the present technology.

FIG. 17 is a flowchart showing an example of an operation of an analysis device according to the first embodiment of the present technology.

FIG. 18 is a block diagram illustrating a configuration example of an imaging section according to a first modification of the first embodiment of the present technology.

FIG. 19 is a block diagram illustrating a configuration example of an imaging device according to a second embodiment of the present technology.

FIG. 20 is a block diagram illustrating a configuration example of an imaging device according to a third embodiment of the present technology.

FIG. 21 is a flowchart showing an example of an operation of an analysis device according to the third embodiment of the present technology.

FIG. 22 is a block diagram illustrating a configuration example of an imaging device according to a fourth embodiment of the present technology.

FIG. 23 is a block diagram illustrating a configuration example of an imaging device according to a fifth embodiment of the present technology.

FIG. 24 is a view illustrating an example of a layered structure of an image sensor according to the fifth embodiment of the present technology.

FIG. 25 is a block diagram illustrating a configuration example of an imaging device according to a sixth embodiment of the present technology.

FIG. 26 is a block diagram illustrating a schematic configuration example of a vehicle control system.

FIG. 27 is an explanatory view illustrating an example of an installation position of an imaging section.

### DESCRIPTION OF EMBODIMENTS

Hereinafter, modes (hereinafter, referred to as embodiments) for implementing the present technology will be described. The description will be made in the following order.
1. First Embodiment (an example of performing a calculation of a statistic within a frame period)
2. Second Embodiment (an example in which a simple detector, a detail detector, and an evaluator which perform a calculation of a statistic within a frame period are provided inside an SNN circuit)
3. Third Embodiment (an example in which a calculation is performed on a statistic within a frame period and an input control unit controls an image sensor)
4. Fourth Embodiment (an example in which a simple detector and a detail detector which perform a calculation of a statistic within a frame period are provided inside an SNN circuit)
5. Fifth Embodiment (an example in which a simple detector and a detail detector which perform a calculation of a statistic within a frame period are provided inside an image sensor)
6. Sixth Embodiment (an example of selecting a rule on the basis of a detection result of a simple detector which performs a calculation of a statistic within a frame period and a sensor signal)
7. Example of Application to Mobile Body

### 1. First Embodiment

### Configuration Example of Imaging Device

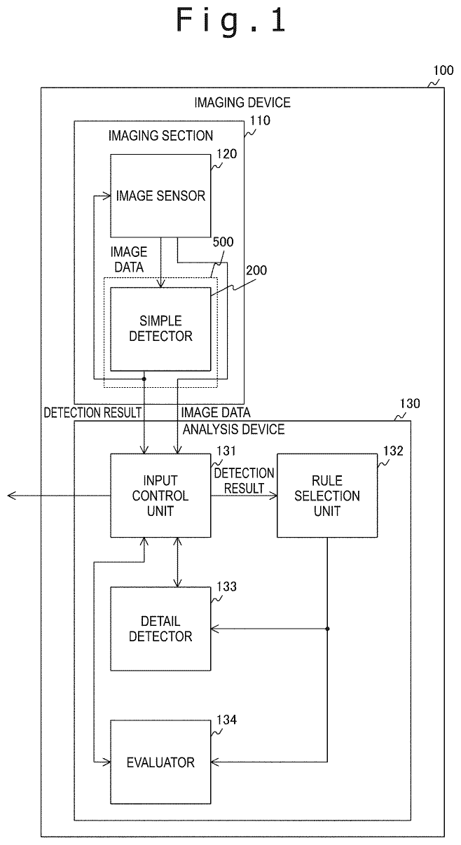

FIG. 1 is a block diagram illustrating a configuration example of an imaging device 100 according to an embodiment of the present technology. The imaging device 100 is a device that images image data, and includes an imaging section 110 and an analysis device 130. The imaging section 110 includes an image sensor 120 and a simple detector 200.

The image sensor 120 generates image data by photoelectric conversion. The image sensor 120 determines whether a light amount has changed for each pixel address, and generates, as image data, data in which determination results are arrayed. Such a sensor is called an event-based vision sensor (EVS) or a dynamic vision sensor (DVS). By using the EVS, an input of the simple detector 200 becomes sparse, and even when a significant periodic change is generated in the input, the input can be further made sparse in the simple detector 200.

The image sensor 120 is not limited to the EVS, and may generate a gradation signal in accordance with the light amount for each pixel and generate image data in which the gradation signals are arrayed. When generating the gradation signal, the image sensor 120 generates an analog signal for each pixel and converts the analog signal into a digital signal by an analog to digital (AD) converter. Alternatively, the image sensor 120 includes a single-photon avalanche diode (SPAD) for each pixel, and counts pulse signals from the SPAD to generate a digital signal.

The image sensor 120 switches an output destination of the image data to either the simple detector 200 or the analysis device 130 on the basis of a detection result of the simple detector 200.

The image sensor 120 can also change a resolution of image data to be generated, on the basis of the detection result of the simple detector 200. The resolution is changed by pixel addition, decimation readout, the like. In this case, for example, the image sensor 120 lowers the resolution of the image data to the simple detector 200 and increases the resolution of the image data to the analysis device 130.

The simple detector 200 detects a predetermined detection target from the image data by analysis. A function of the simple detector 200 is implemented as hardware in an SNN circuit 500, for example. Note that the SNN circuit 500 is an example of the neural network circuit described in the appended claims.

In the simple detector 200, for example, a person or a specific preliminary motion is set as a detection target. The simple detector 200 detects whether the detection target (such as a person) is present and supplies the detection result to the analysis device 130 and the image sensor 120. When the detection result is a predetermined value P, the image sensor 120 changes the output destination of the image data to the analysis device 130. Here, the number of predetermined values P is not limited to one, and there may be two or more predetermined values P, such as P₀ and P₁. Detection targets are assigned to P₀ and P₁, respectively. The detection result being the predetermined value P indicates that the detection target corresponding to the value has been detected.

The analysis device 130 includes an input control unit 131, a rule selection unit 132, a detail detector 133, and an evaluator 134.

The input control unit 131 transmits and receives data to and from the outside of the analysis device 130, and the rule selection unit 132, the detail detector 133, and the evaluator 134. The input control unit 131 supplies the detection result from the simple detector 200 to the rule selection unit 132. The input control unit 131 also supplies the image data from the image sensor 120 to at least one of the detail detector 133 and the evaluator 134. The input control unit 131 also supplies the detection result from the detail detector 133 to the rule selection unit 132, and transmits logs and alerts from the detail detector 133 and the evaluator 134 to a server of the outside or the like.

The rule selection unit 132 selects a rule for controlling operations of the detail detector 133 and the evaluator 134 on the basis of the detection result of the simple detector 200. For example, various rules such as “activate the evaluator 134 when a specific detection target is detected by the detail detector 133” and “output an alert to the outside when a predetermined evaluation value is obtained by the evaluator 134” are assumed. The rule selection unit 132 controls the operations of the detail detector 133 and the evaluator 134 in accordance with a rule selected from among the rules.

For example, according to a certain rule, when the detection result of the simple detector 200 is not the predetermined value P, the rule selection unit 132 stops the operations of the detail detector 133 and the evaluator 134. On the other hand, when the detection result of the simple detector 200 is the predetermined value P, the rule selection unit 132 causes the detail detector 133 to start analysis while keeping the evaluator 134 stopped. Then, when the detection result of the detail detector 133 is a predetermined value Q, the rule selection unit 132 causes the evaluator 134 to start analysis. Here, the number of predetermined values Q is not limited to one, and there may be two or more predetermined values, such as Q₀ or Q₁. The detection result being the predetermined value Q indicates that the detection target corresponding to the value has been detected.

The detail detector 133 detects a predetermined detection target from the image data by a more detailed analysis than the simple detector 200. For example, whether a person is present, the number of persons, whether a specific motion is performed, and the location of a person in an image are set as detection targets. Further, when the detail detector 133 has detected a person, the detail detector 133 can also detect whether the person is a specific individual. The detail detector 133 may perform these analyses on one piece of image data or a moving image including a plurality of pieces of image data imaged successively.

The detail detector 133 outputs the detection result to the input control unit 131. Further, when the detail detector 133 has detected a specific individual, the detail detector 133 can generate a log including a photographing time and output the log to the input control unit 131.

The evaluator 134 generates an evaluation value from the image data by an analysis different from that by the detail detector 133. The evaluator 134 analyzes, for example, what kind of motion one or more persons are performing and what kind of state they are in, and generates an evaluation value indicating the result. The evaluator 134 may perform these analyses on one piece of image data or a moving image.

For example, according to a certain rule, when the evaluation value is a predetermined value R, the evaluator 134 outputs a log including the photographing time or an alert to the input control unit 131. Here, the number of predetermined values R is not limited to one, and there may be two or more predetermined values R, such as R₀ and R₁. The evaluation value being the predetermined value P indicates that the analysis target corresponding to the value has been detected.

As described above, a system in which the simple detector 200 continuously detects a detection target and causes the detail detector 133 and the evaluator 134 to operate when the detection target has been detected is referred to as an Always-ON system. By the Always ON system, power consumption can be reduced while maintaining the performance, as compared with a case where the detail detector 133 and the evaluator 134 are always operated.

In FIG. 1, the imaging section 110 and the analysis device 130 are disposed in one device, but this configuration is not necessarily employed. These may be distributed over a plurality of devices. A system in which the imaging section 110 and the analysis device 130 are disposed is an example of the imaging system described in the appended claims.

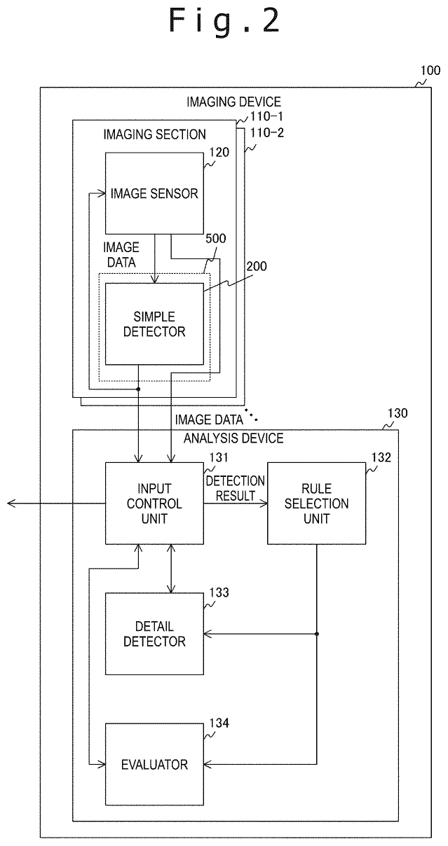

In FIG. 1, one imaging section 110 is disposed, but this configuration is not necessarily employed. As illustrated in FIG. 2, a plurality of imaging sections such as imaging sections 110-1 and 110-2 may be disposed.

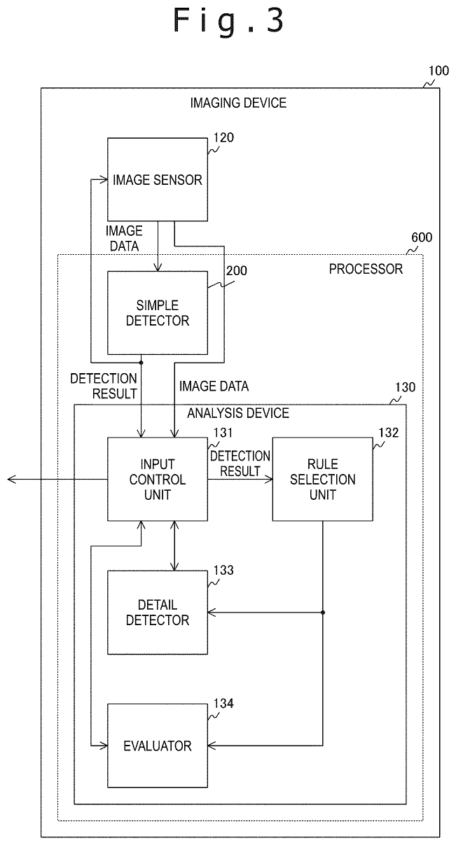

As illustrated in FIG. 3, the simple detector 200 and the analysis device 130 may be disposed in one processor 600.

### Configuration Example of SNN Circuit

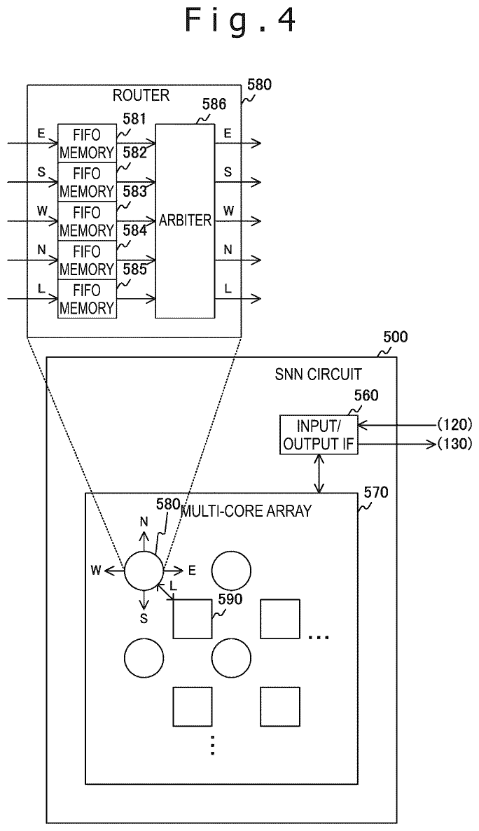

FIG. 4 is a view illustrating a mounting example of the SNN circuit 500 according to the first embodiment of the present technology. The SNN circuit 500 includes, for example, an input/output interface 560 and a multi-core array 570.

The input/output interface 560 transmits and receives data to and from the outside and the multi-core array 570. The input/output interface 560 supplies the image data from the image sensor 120 to the multi-core array 570, and supplies the detection result from the multi-core array 570 to the analysis device 130.

In the multi-core array 570, a plurality of cores 590 are arrayed in a two-dimensional lattice pattern. A router 580 is disposed adjacent to each core 590.

The router 580 controls a path of data. The router 580 includes, for example, first-in, first-out (FIFO) memories 581 to 585 and an arbiter 586. In FIG. 4, “E” indicates the east direction, and “S” indicates the south direction of the router 580 of interest. “W” indicates the west direction and “N” indicates the north direction. “L” indicates a direction to the core 590 adjacent to the router 580.

The FIFO memory 581 holds data from the east direction in a first-in first-out manner, and outputs a request to the arbiter 586. The FIFO memory 582 holds data from the south direction in the first-in first-out manner, and outputs a request to the arbiter 586. The FIFO memory 583 holds data from the west direction in the first-in first-out manner, and outputs a request to the arbiter 586. The FIFO memory 584 holds data from the north direction in the first-in first-out manner, and outputs a request to the arbiter 586. The FIFO memory 585 holds data from the adjacent core 590 in the first-in first-out manner, and outputs a request to the arbiter 586.

The arbiter 586 arbitrates the requests from the FIFO memories 581 to 585 and returns responses. When receiving a response, the FIFO memory outputs data to any of the north, south, east, and west and the adjacent core 590 via the arbiter 586.

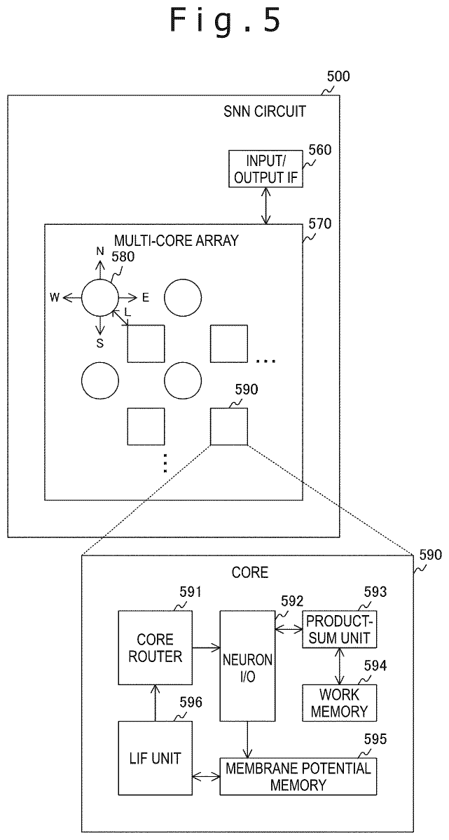

FIG. 5 is a block diagram illustrating a configuration example of the core 590 according to the first embodiment of the present technology. The core 590 includes a core router 591, a neuron input/output (I/O) 592, a product-sum unit 593, a work memory 594, a membrane potential memory 595, and a leaky integrate and fire (LIF) unit 596.

The core router 591 supplies data from the adjacent router 580 to the neuron I/O 592 and supplies data from the LIF unit 596 to the adjacent router 580.

The product-sum unit 593 integrates data from the neuron I/O 592 by using the work memory 594. The membrane potential memory 595 holds a membrane potential obtained by the integration. The LIF unit 596 determines whether the membrane potential has exceeded a predetermined threshold and firing has occurred (in other words, a spike has occurred), and supplies the result to the core router 591.

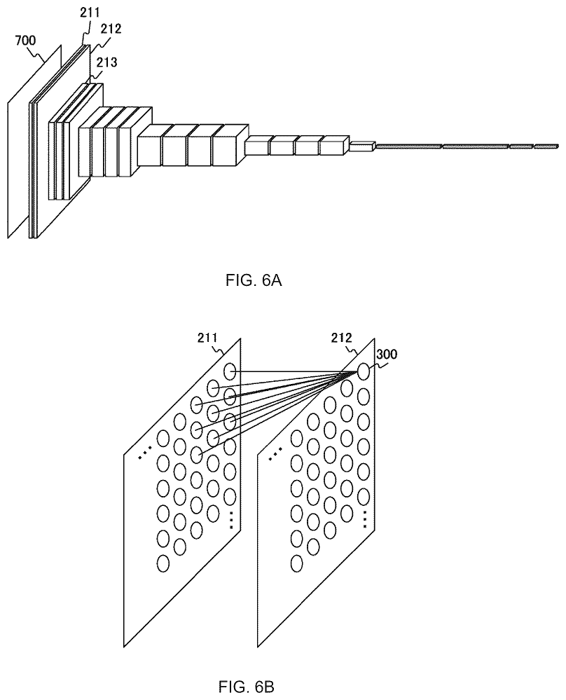

FIG. 6 is views illustrating an example of a neural network structure of the simple detector 200 according to the first embodiment of the present technology. FIG. 6a illustrates an example of the neural network structure, and FIG. 6b illustrates an example of a structure of two layers in FIG. 6a. Circles in FIG. 6b indicate neurons.

As illustrated in FIG. 6a, the neural network in the simple detector 200 is, for example, a convolutional neural network (CNN), and is composed of multiple layers such as convolutional layers 211 and 212 and a pooling layer 213. Each of the neurons in the convolutional layer 211, which is the first layer, receives an input of each pixel signal of one or more pixels in image data 700. The neural network is not limited to the CNN.

As illustrated in FIG. 6b, for example, a predetermined number of ΔΣ neurons 300 are arrayed in the convolutional layer 212. In FIG. 6, for the sake of simplicity, a channel direction is omitted and a two-dimensional representation is used, and the same applies to a case of a three-dimensional representation.

As illustrated in FIG. 6b, the plurality of neurons including one or more ΔΣ neurons 300 are arrayed in the neural network. As these neurons, spiking neurons in the SNN are used, for example. Note that general neurons in an artificial neural network (ANN) can also be used. The spiking neurons and the general neurons may be combined.

### Configuration Example of ΔΣ Neuron

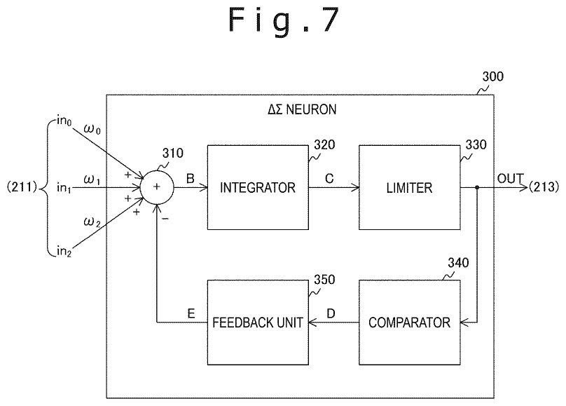

FIG. 7 is a block diagram illustrating a configuration example of the ΔΣ neuron 300 according to the first embodiment of the present technology. The ΔΣ neuron 300 includes a difference calculator 310, an integrator 320, a limiter 330, a comparator 340, and a feedback unit 350.

The difference calculator 310 performs a calculation of a difference B between the sum of a predetermined number of input signals and a feedback signal E from the feedback unit 350, and supplies the difference B to the integrator 320. For example, in₀×ω₀, in₁×ω₁, and in₂×ω₂ are input as input signals, where in₀, in₁, and in₂ are the outputs of the neurons in the preceding stage and ω₀, ω₁, and ω₂ are the weights thereof.

The integrator 320 integrates the difference B and supplies an integral value C to the limiter 330.

When the integral value C is out of a predetermined limit range, the limiter 330 outputs the value as an output signal OUT to the pooling layer 213 and the comparator 340 in a subsequent stage. For example, an upper threshold limit value of the limit range is set to Th₀, and a lower threshold limit value is set to Th₁. The limiter 330 outputs the output signal OUT of “0” when the integral value C is Th₀ or more and Th₁ or less. The output signal OUT being “0” means that a significant output signal is not output and a limit is imposed. On the other hand, when the integral value C is less than Th₀ or the integral value C is more than Th₁, the limiter 330 outputs the integral value C as it is as the output signal OUT.

The comparator 340 compares the output signal OUT with a predetermined comparison threshold value TH, and supplies a comparison result D to the feedback unit 350. For example, “0” is set as TH, and the comparator 340 outputs “1” as the comparison result when the output signal OUT is more than TH, and outputs “0” as the comparison result when the output signal OUT is TH or less.

The feedback unit 350 converts the comparison result D into the feedback signal E and feeds back the feedback signal E to the difference calculator 310. For example, the feedback unit 350 outputs the feedback signal E of “−1” when the comparison result D is more than “0”, and outputs the feedback signal E of “1” when the comparison result D is “0”.

The above-described ΔΣ neuron 300 performs a calculation of the output signal OUT and outputs it at regular time intervals in synchronization with a clock signal having a predetermined processing frequency. In the above configuration, a time derivative of the integral value C is expressed by, for example, the following equation.

dC/dt=−(C−a)/T+Σ(ωj×inj)−Δ(out) Equation 1

In the above equation, t represents time, and a represents a coefficient. T represents a time constant, and Δ( ) represents a comparison result of the comparator 340.

The value of the output signal OUT is expressed by the following equation.

OUT=f(C) Equation 2

In the above equation, f( ) represents an activation function of the limiter 330.

The input signal and the output signal of the ΔΣ neuron 300 are both digital signals. The input signal may be an analog signal and the output signal may be a digital signal. In this case, a 1-bit digital-to-analog converter (DAC) or the like is used as the feedback unit 350. Further, both the input signal and the output signal may be analog signals.

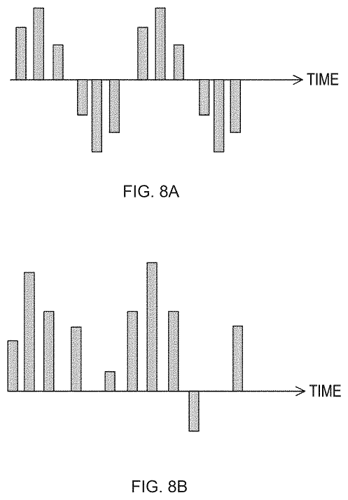

FIG. 8 is diagrams illustrating examples of an input signal and an output signal of the ΔΣ neuron 300 according to the first embodiment of the present technology. FIG. 8a illustrates an example of a trajectory of the input signal with the elapse of time, and FIG. 8b illustrates an example of a trajectory of the output signal.

As illustrated in FIG. 8a and FIG. 8b, the input signal is input and a calculation of the output signal is performed per unit time. These input signal and output signal are, for example, n-bit (n is an integer) spike signals. Such neurons are referred to as spiking neurons. The ΔΣ neuron 300 is not limited to a spiking neuron, and may be a general neuron the input signal and the output signal of which are not the spike signals.

Here, a general ΔΣ neuron without the limiter 330 is assumed as the first comparative example.

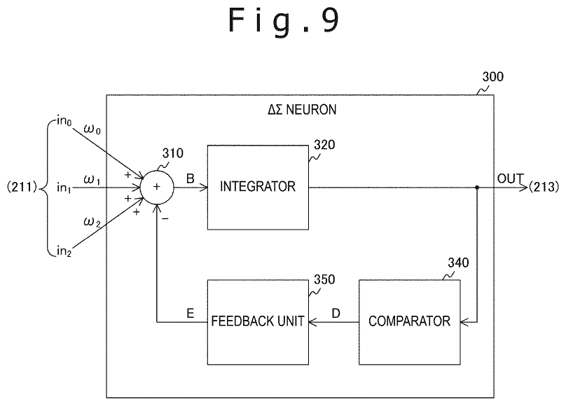

FIG. 9 is a block diagram illustrating a configuration example of the ΔΣ neuron according to the first comparative example of the present technology. As illustrated in FIG. 9, in the first comparative example, the limiter 330 is not disposed, and the integral value is output as it is as the output signal OUT and is input to the comparator 340. In the first comparative example, the neuron firing rate is controlled by the comparison threshold value TH of the comparator 340. When the comparison threshold value TH is increased, the firing rate is reduced, and the sparsity can be improved accordingly.

Here, in the above-described Always ON system, data, including the input from the image sensor 120, is made sparse in both time and space as much as possible; thus, the Always ON system can be operated more efficiently.

In the ANN, processing can be made sparse only in the time direction by changing the processing frequency, whereas in the SNN, information can be made sparse in both time and space by preventing each neuron from transmitting unnecessary information. Since spatial sparsification is possible in the SNN, unlike the ANN, the sparsity comparable to a slow ANN can be obtained while the processing frequency is maintained.

Thus, by using the SNN as the simple detector 200, both maintenance of the processing frequency and efficiency of the processing can be achieved.

However, there is a trade-off relationship between the sparsity and the performance. In the first comparative example, when the comparison threshold value TH of each neuron is increased, the neuron firing rate is reduced and the sparsity is improved, but the amount of information to be transmitted becomes insufficient and errors of the analysis result increase.

In the first comparative example, only the comparison threshold value TH is controlled, whereas in the ΔΣ neuron 300 in which the limiter 330 is provided, two types of threshold values of the comparison threshold value TH and the threshold values (the upper threshold limit value and the lower threshold limit value) of the limiter 330 can be controlled. In this configuration, by widening the limit range from the lower threshold limit value to the upper threshold limit value, the sparsity can be improved. On the other hand, by lowering the comparison threshold value TH, an information loss can be minimized. Thus, by outputting the integral value C through the limiter 330 instead of directly outputting the integral value C, the information loss when the sparsity is increased can be minimized. This makes it possible to suppress the performance degradation when the sparsity is improved.

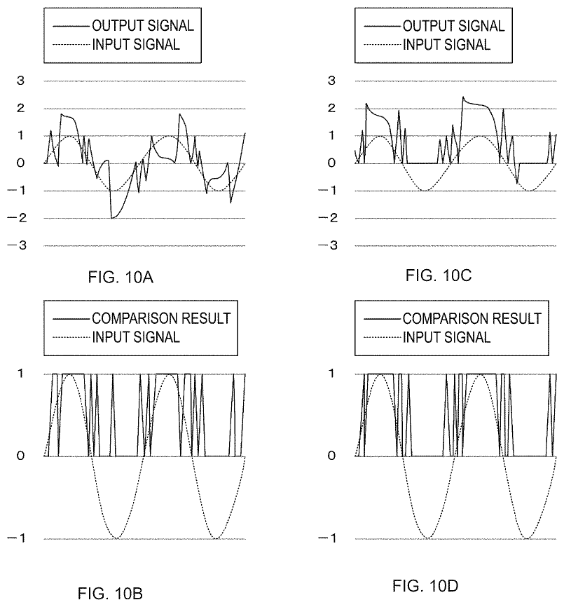

FIG. 10 is graphs showing examples of waveforms of output signals and comparison results when sine waves are input in the first comparative example and the first embodiment of the present technology. FIG. 10a is an example of the waveforms of the input signal and the output signal when the sine waves are input to the neuron of the first comparative example, and FIG. 10b is an example of the waveforms of the input signal and the comparison result in the above case.

In addition, FIG. 10c is an example of the waveforms of the input signal and the output signal when the sine waves are input to the ΔΣ neuron 300 with the limiter 330, and FIG. 10d is an example of the waveforms of the input signal and the comparison result in the above case.

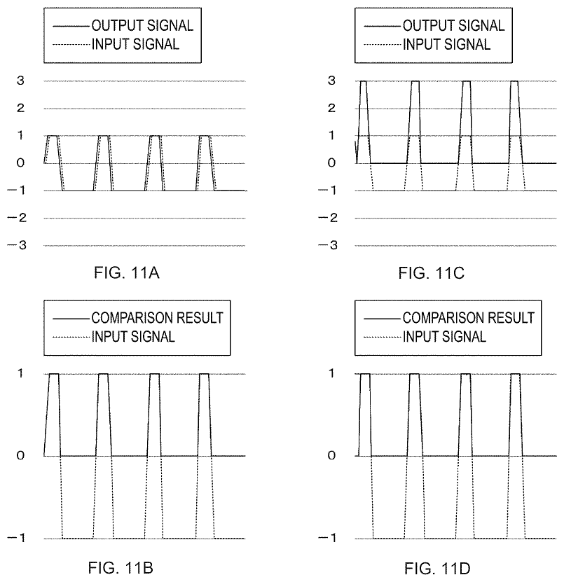

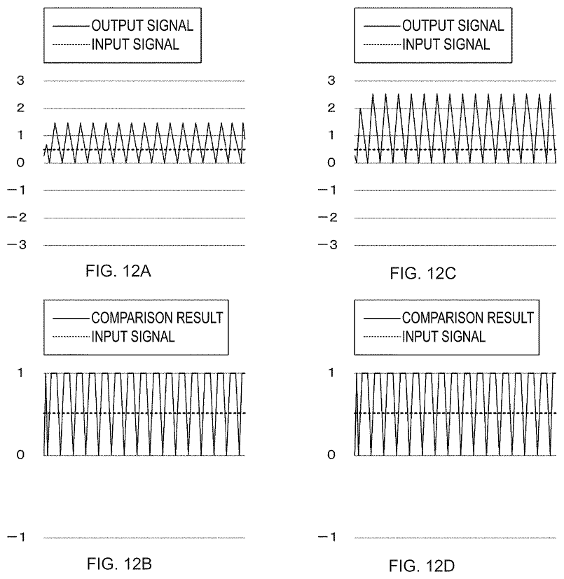

Dotted lines in FIG. 10a to FIG. 10d show the waveforms of the input signals. A solid line in FIG. 10a represents the waveform of the output signal (that is, the integral value), and a solid line in FIG. 10b represents the waveform of the comparison result. A solid line in FIG. 10c represents the waveform of the output signal from the limiter 330, and a solid line in FIG. 10d represents the waveform of the comparison result. The same applies to FIGS. 11 and 12.

As shown in FIG. 10a to FIG. 10d, in the configuration in which the limiter 330 is provided, a compression ratio is higher and the information loss is smaller for information having periodicity such as sine waves than in the first comparative example. It should be noted that the information loss increases for an input that varies in a complicated manner.

FIG. 11 is graphs showing examples of waveforms of output signals and comparison results when a sparse signal is input in the first comparative example and the first embodiment of the present technology. FIG. 11a is an example of the waveforms of the input signal and the output signal when the sparse signal is input to the neuron of the first comparative example, and FIG. 11b is an example of the waveforms of the input signal and the comparison result in the above case.

In addition, FIG. 11c is an example of the waveforms of the input signal and the output signal when the sparse signal is input to the ΔΣ neuron 300 with the limiter 330, and FIG. 11d is an example of the waveforms of the input signal and the comparison result in the above case.

As shown in FIG. 11a to FIG. 11d, in the configuration in which the limiter 330 is provided, the compression ratio when the sparse signal is input is almost equal to that of the first comparative example.

FIG. 12 is graphs showing examples of waveforms of output signals and comparison results when a stationary signal is input in the first comparative example and the first embodiment of the present technology. FIG. 12a is an example of the waveforms of the input signal and the output signal when the stationary signal is input to the neuron of the first comparative example, and FIG. 12b is an example of the waveforms of the input signal and the comparison result in the above case.

In addition, FIG. 12c is an example of the waveforms of the input signal and the output signal when the stationary signal is input to the ΔΣ neuron 300 with the limiter 330, and FIG. 12d is an example of the waveforms of the input signal and the comparison result in the above case.

As shown in FIG. 12a to FIG. 12d, in the configuration in which the limiter 330 is provided, the compression ratio when the stationary signal is input is almost equal to that of the first comparative example.

Next, an output format of an output layer in the neural network of the simple detector 200 will be described.

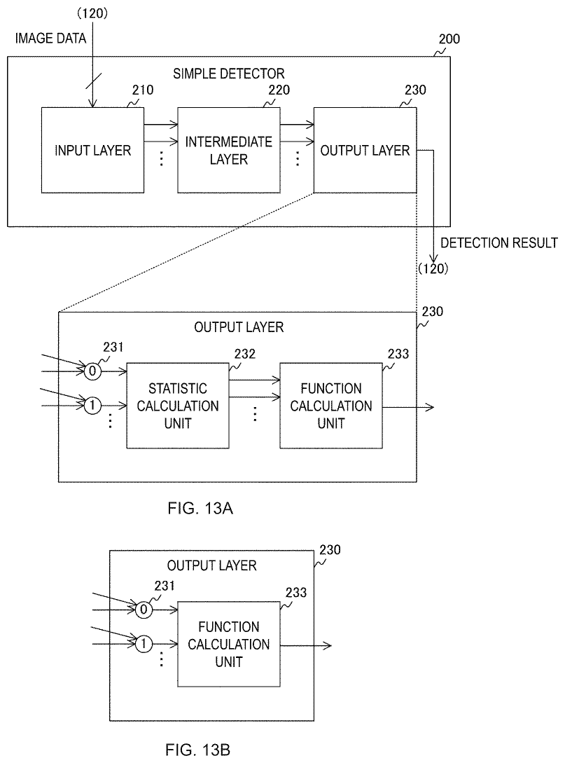

FIG. 13 is block diagrams illustrating configuration examples of simple detectors 200 according to the first embodiment of the present technology and the second comparative example. FIG. 13a is a block diagram illustrating a configuration example of the simple detector 200 according to the first embodiment.

The neural network in the simple detector 200 includes an input layer 210, an intermediate layer 220, and an output layer 230. The input layer 210 processes the image data from the image sensor 120 and supplies an array of spike signals to the intermediate layer 220. The intermediate layer 220 processes the array of the spike signals and supplies the array of the spike signals to the output layer 230. The output layer 230 includes a predetermined number of output-side neurons 231, a statistic calculation unit 232, and a function calculation unit 233.

Each of the output-side neurons 231 generates an output signal on the basis of an input signal from the intermediate layer every time a unit time elapses, and supplies the output signal to the statistic calculation unit 232. When the number of the output-side neurons 231 is M (M is an integer), an array of M output signals is output per unit time. The length of the unit time is, for example, 1 millisecond.

The statistic calculation unit 232 performs, for each output-side neuron 231, a calculation of a statistic of output signals generated within a predetermined frame period longer than the unit time. The largest value, a sum, or an average value is calculated as the statistic.

The statistic calculation unit 232 supplies the array of the M statistics as Logit to the function calculation unit 233.

The function calculation unit 233 outputs, to the analysis device 130, a value of a solution (in other words, a calculation value) obtained by inputting Logit to a predetermined function (such as a softmax function), as a detection result.

Here, a configuration in which the statistic calculation unit 232 is not disposed is assumed as the second comparative example. FIG. 13b is a block diagram illustrating a configuration example of the output layer 230 in the second comparative example. In the second comparative example, the array of the output signals of the output-side neurons 231 is input as Logit to the function calculation unit 233.

In FIG. 13, the function calculation unit 233 outputs a solution as the detection result, but this configuration is not necessarily employed. As described later, the simple detector 200 may output the array of statistics (Logit) to the analysis device 130 without performing a calculation of a solution.

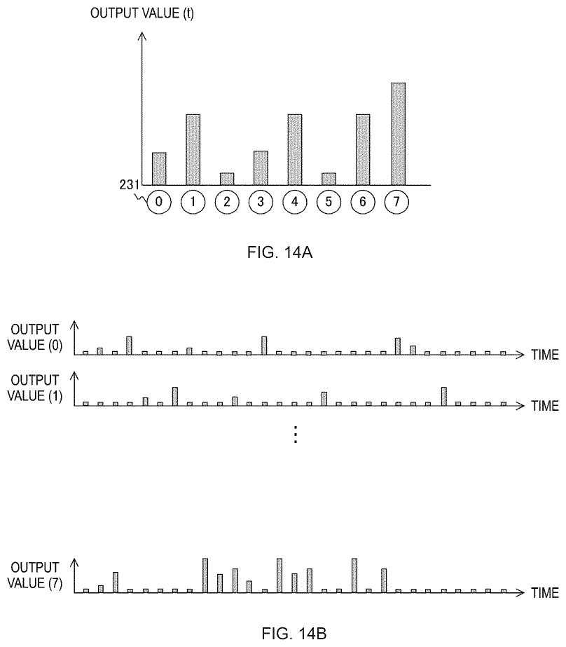

FIG. 14 is diagrams each showing an example of output values of the output-side neurons 231 according to the first embodiment of the present technology. FIG. 14a is a diagram showing an example of the output value of each output-side neuron 231 at a certain time t. For example, eight output-side neurons 231 are arrayed, and identification numbers thereof are “0” to “7”. Circles in FIG. 14a indicate the output-side neurons 231. The output values of these neurons are, for example, n-bit spike values.

FIG. 14b is a diagram showing the output value of each output-side neuron 231 in chronological order. As shown as an example in FIG. 14b, each of the eight output-side neurons 231 outputs an output value (spike value or the like) per unit time. The numerical value in parentheses in FIG. 14b indicates the identification number of the output-side neuron 231.

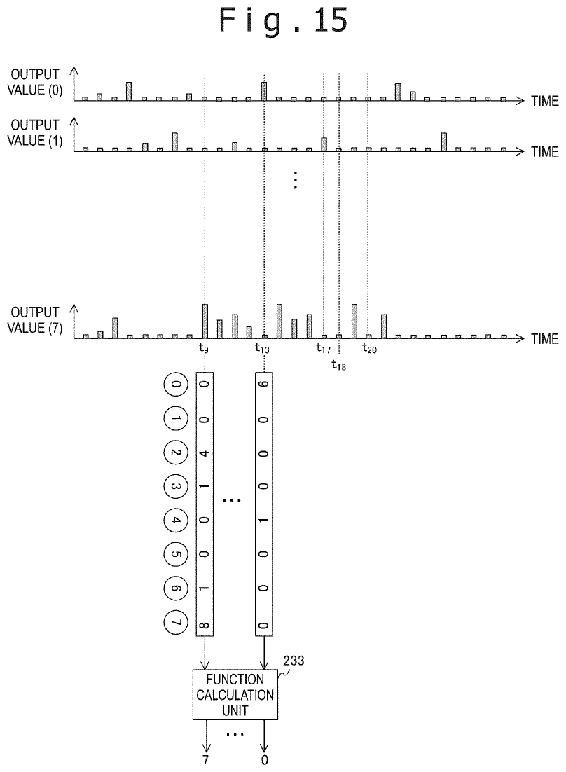

FIG. 15 is a diagram showing an example of an output format according to the second comparative example. At Time t₀, an array of eight output values (that is, Logit) is input to the function calculation unit 233. The function calculation unit 233 outputs, as a solution, the identification number of the output-side neuron 231 corresponding to the largest output value in Logit, for example. After Time t₁₀, the same processing is repeatedly executed per unit time.

In the second comparative example, improving the sparsity of the spike signals in the time direction in the SNN increases the number of pieces of zero information when the function calculation unit 233 performs a calculation of a solution, and thus an appropriate solution might not be obtained.

For example, when it is assumed that “7” is a correct solution in a period from Time t₀ to Time t₂₀, the function calculation unit 233 erroneously outputs “0” at Time t₁₃. Also, at Time t₁₇, Time t₁₈, and Time t₂₀, the output value of the output-side neuron 231 with the identification number “7” is not the largest, and an erroneous solution is output.

In order to obtain an appropriate solution, the output layer 230 may accumulate non-zero information for a sufficiently long time, but in this case, an output frequency of the simple detector 200 decreases, and a delay increases. In addition, the evaluation of the analysis device 130 in the subsequent stage is also delayed or inaccurate, which is not preferable.

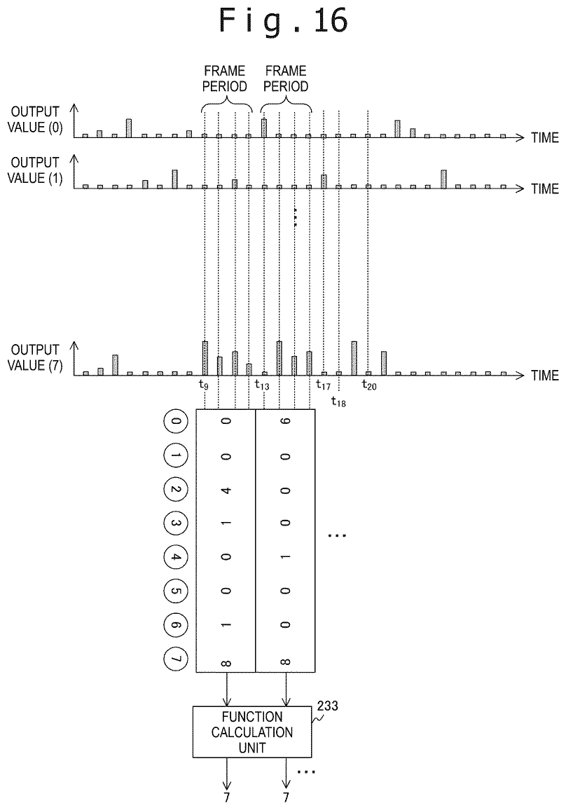

FIG. 16 is a diagram showing an example of an output format according to the first embodiment of the present technology. As shown in FIG. 16, in the first embodiment, a frame period (4× unit time or the like) longer than the unit time is set. The statistic calculation unit 232 performs, for each output-side neuron 231, a calculation of a statistic (such as the largest value) of the output signals generated within the frame period. For example, within a frame period including Time t₀ to Time t₁₂, the output-side neuron 231 with the identification number “7” sequentially outputs four output values. When the largest value of these is “8”, the statistic calculation unit 232 obtains “8” as the statistic of the neuron. The statistic calculation unit 232 also obtains statistics for other neurons, and supplies an array of eight statistics as Logit to the function calculation unit 233. The same processing is performed in the next frame period including Time t₁₃ to Time t₁₆. The function calculation unit 233 outputs, as a solution, the identification number of the output-side neuron 231 corresponding to the largest output value in Logit.

In the second comparative example, the erroneous solution is output at Time t₁₃, but as shown in FIG. 16, the output layer 230 can output “7”, which is a correct solution, in a frame period including Time t₁₃ by performing calculations of the statistics. Similarly, at Time t₁₇, Time t₁₈, and Time t₂₀, the output layer 230 can output correct solutions.

As shown in FIG. 16, by performing calculations of the statistics, the output of an erroneous solution can be suppressed when the sparsity is improved in a time axis direction. In addition, since it is not necessary to accumulate non-zero information for a long time, a decrease in the output frequency and an increase in the delay can be suppressed as compared with the second comparative example. This makes it possible to suppress degradation in performance when the sparsity is improved.

### Operation Example of Analysis Device

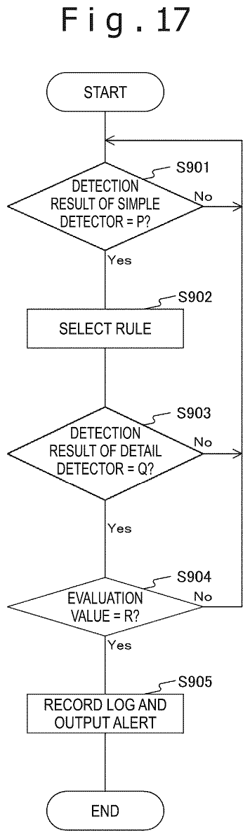

FIG. 17 is a flowchart showing an example of an operation of the analysis device 130 according to the first embodiment of the present technology. This operation is started, for example, when the simple detector 200 outputs a detection result.

The rule selection unit 132 determines whether the detection result of the simple detector 200 is the predetermined value P (in other words, whether a predetermined detection target is detected) (Step S901). If the detection result is not P (Step S901: No), then the rule selection unit 132 returns to Step S901.

On the other hand, if the detection result is P (Step S901: Yes), then the rule selection unit 132 selects a rule on the basis of the detection result, and activates the detail detector 133 in accordance with the rule, for example (Step S902).

The rule selection unit 132 determines whether the detection result of the detail detector is the predetermined value Q (Step S903). If the detection result is not Q (Step S903: No), then the rule selection unit 132 repeats Step S901 and subsequent steps.

On the other hand, if the detection result is Q (Step S903: Yes), then the rule selection unit 132 activates the evaluator 134, for example, and determines whether the evaluation value is the predetermined value R (Step S904). If the evaluation value is not R (Step S904: No), then the rule selection unit 132 repeats Step S901 and the subsequent steps.

On the other hand, if the evaluation value is R (Step S904: Yes), then the evaluator 134 records a log and outputs an alert (Step S905), and the analysis device 130 ends the operation for analysis.

The rules shown in Steps S903 through S905 above are examples of the rule selected in Step S902. The contents of the rules are not limited to those shown as an example in the flowchart. For example, the rule selection unit 132 may activate only one of the detail detector 133 and the evaluator 134 when the detection result is P. Alternatively, the evaluator 134 may only output the alert at Step S905.

As described above, according to the first embodiment of the present technology, since the statistic calculation unit 232 performs, for each output-side neuron 231, a calculation of a statistic of the output signals generated within the frame period, degradation in performance due to an erroneous solution when the sparsity is improved can be suppressed.

Further, since the limiter 330 that outputs the integral value as the output signal when the integral value is out of the predetermined range is provided in the ΔΣ neuron 300, the information loss when the sparsity is improved can be minimized.

### Modification

In the first embodiment described above, the statistic calculation unit 232 performs a calculation of the statistics within the frame period, and the frame period can also be variable. The imaging device 100 according to the first embodiment is different from that according to the first embodiment in that the length of the frame period is controlled in accordance with the output of the simple detector 200.

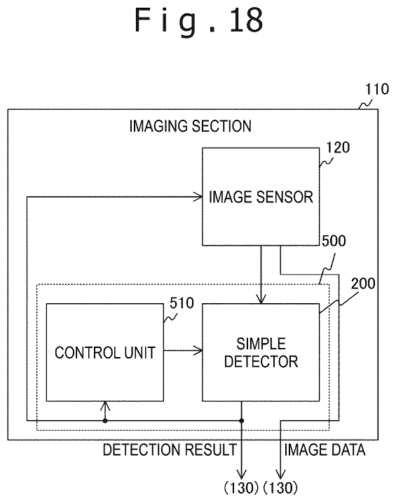

FIG. 18 is a block diagram illustrating a configuration example of the imaging section 110 according to a first modification of the first embodiment of the present technology. The imaging section 110 according to the first modification of the first embodiment is different from that according to the first embodiment in that a control unit 510 is further included. The control unit 510 is provided in the SNN circuit 500, for example.

The control unit 510 controls the length of the frame period in accordance with the detection result (that is, the solution of the function calculation unit 233) of the simple detector 200. For example, the control unit 510 sets the frame period to be shorter than a predetermined value when the solution is smaller than a predetermined set value, and sets the frame period to be longer than the predetermined value when the solution is the set value or more.

The simple detector 200 may output Logit. In this case, for example, the control unit 510 obtains a solution from Logit and controls the frame period in accordance with the solution.

By making the frame period (in other words, a frame rate) variable, an effect of substantially decimating the output of the simple detector 200 in a time period in which the output of the simple detector 200 is sparse is obtained.

In addition, when the output frequency of the simple detector 200 is high, the control unit 510 determines that important information is received, and may increase the operation frequency of the analysis device 130, thereby improving the efficiency so that the entire system performs a necessary operation.

The control unit 510 may control the threshold value of a neuron in the simple detector 200 in accordance with the detection result (solution or Logit) of the simple detector 200. For example, the control unit 510 increases the threshold value in a time period in which the solution is larger than the set value, and decreases the threshold value in a time period in which the solution is the set value or less, thereby reducing the output of the simple detector 200. In the case of the ΔΣ neuron 300 described above, the comparison threshold value and the upper threshold limit value and the lower threshold limit value of the limit range are controlled.

Note that the control of the frame period and the like is performed by the control unit 510 in the SNN circuit 500, but this configuration is not necessarily employed. The outside of the SNN circuit 500, for example, the input control unit 131 may control the frame period and the like.

As described above, according to the modification of the first embodiment of the present technology, since the control unit 510 controls the length of the frame period in accordance with the detection result of the simple detector 200, an appropriate frame rate according to the detection result can be set.

### 2. Second Embodiment

In the first embodiment described above, the simple detector 200 is provided in the SNN circuit 500, but the detail detector 133 and the evaluator 134 may be further provided. The imaging device 100 according to a second embodiment is different from that according to the first embodiment in that the simple detector 200, the detail detector 133, and the evaluator 134 are provided in the SNN circuit 500.

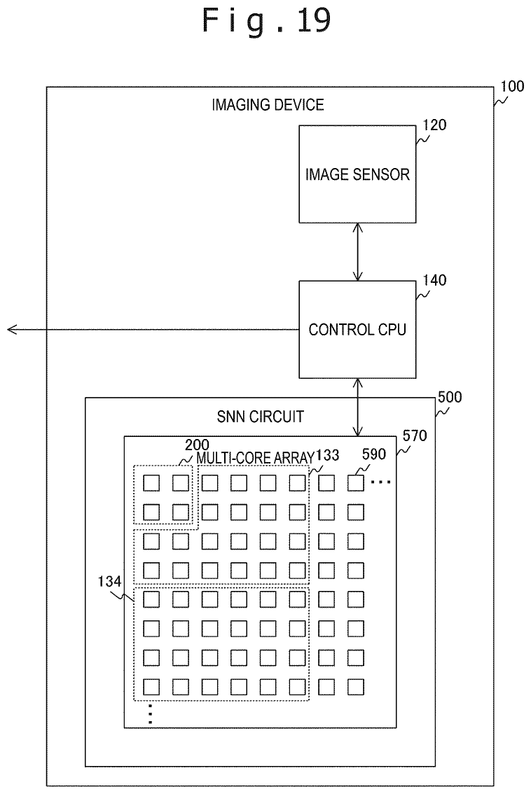

FIG. 19 is a block diagram illustrating a configuration example of the imaging device 100 according to the second embodiment of the present technology. The imaging device 100 according to the second embodiment includes the image sensor 120, a control central processing unit (CPU) 140, and the SNN circuit 500.

The multi-core array 570 of the SNN circuit 500 is divided into a plurality of regions, and the functions of the simple detector 200, the detail detector 133, and the evaluator 134 are assigned to the regions. In FIG. 19, a router and an input/output interface are omitted.

The control CPU 140 has the functions of the input control unit 131 and the rule selection unit 132 of the first embodiment. The control CPU 140 can also control set values related to the output of the image sensor 120 on the basis of an output state of at least one of the simple detector 200, the detail detector 133, and the evaluator 134. For example, the set values related to a range of pixels to perform output and characteristics such as gains of pixels are controlled.

As illustrated in FIG. 19, by providing the simple detector 200, the detail detector 133, and the evaluator 134 in the SNN circuit 500, it is not necessary to dispose the detail detector 133 and the evaluator 134 outside the SNN circuit 500.

The modification of the first embodiment can also be applied to the second embodiment.

As described above, according to the second embodiment of the present technology, since the simple detector 200, the detail detector 133, and the evaluator 134 are provided in the SNN circuit 500, it is not necessary to dispose the detail detector 133 and the evaluator 134 outside the SNN circuit 500.

### 3. Third Embodiment

In the first embodiment described above, the simple detector 200 performs a calculation of a solution from Logit and outputs the solution as a detection result, but may output Logit as it is as a detection result without performing a calculation of a solution. The imaging device 100 according to the third embodiment is different from that according to the first embodiment in that the simple detector 200 outputs Logit.

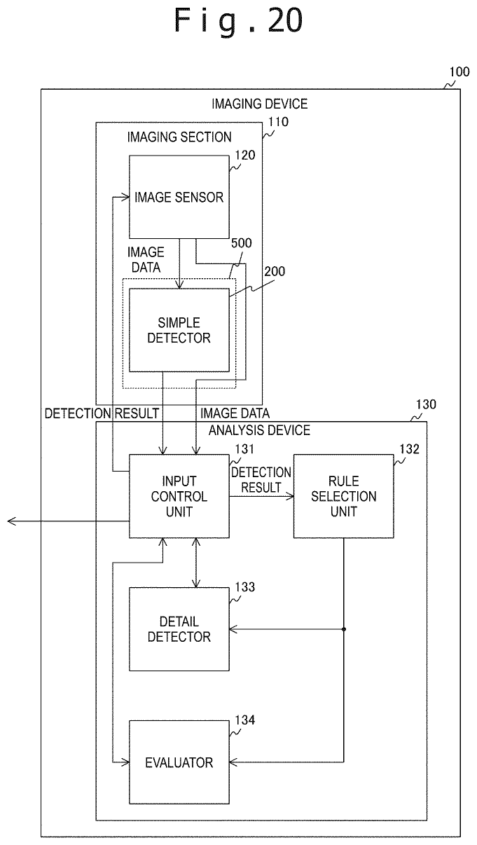

FIG. 20 is a block diagram illustrating a configuration example of the imaging device 100 according to the third embodiment of the present technology. The simple detector 200 according to the third embodiment is different from that according to the first embodiment in that the simple detector 200 does not perform a calculation of a solution and outputs Logit as a detection result to the input control unit 131.

The input control unit 131 performs a calculation of a solution from Logit, controls the image sensor 120 in accordance with the solution, and changes an output destination thereof.

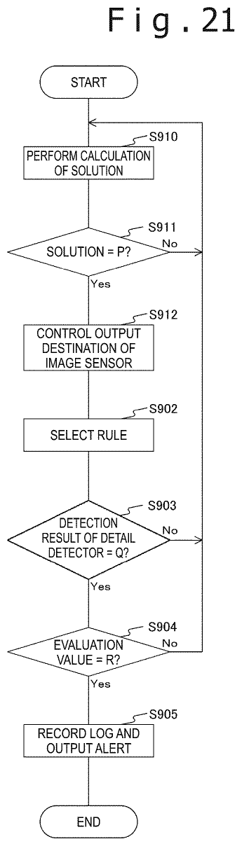

FIG. 21 is a flowchart showing an example of an operation of the analysis device 130 according to the third embodiment of the present technology. The operation in the third embodiment is different from that in the first embodiment in that Steps S910, S911, and S912 are executed instead of Step S901.

The input control unit 131 performs a calculation of a solution from Logit (Step S910), and determines whether the solution is the predetermined value P (Step S911). If the solution is not P (Step S911: No), then the input control unit 131 returns to Step S910.

On the other hand, if the solution is P (Step S911: Yes), then the input control unit 131 controls the output destination of the image sensor 120 to cause the image sensor 120 to output image data to the detail detector 133 or the evaluator 134 in the analysis device 130 (Step S912). After Step S912, Step S902 and the subsequent steps are executed.

As described above, the input control unit 131 performs a calculation of a solution from Logit, and thus the simple detector 200 does not need to perform a calculation of a solution. This can reduce a processing amount of the simple detector 200.

The second embodiment can be applied to the third embodiment.

As described above, according to the third embodiment of the present technology, since the input control unit 131 performs a calculation of a solution from Logit, the simple detector 200 does not need to perform a calculation of a solution.

### 4. Fourth Embodiment

In the first embodiment described above, the simple detector 200 is provided in the SNN circuit 500, but the detail detector 133 may be further provided. The imaging device 100 according to the fourth embodiment is different from that according to the first embodiment in that the simple detector 200 and the detail detector 133 are provided in the SNN circuit 500.

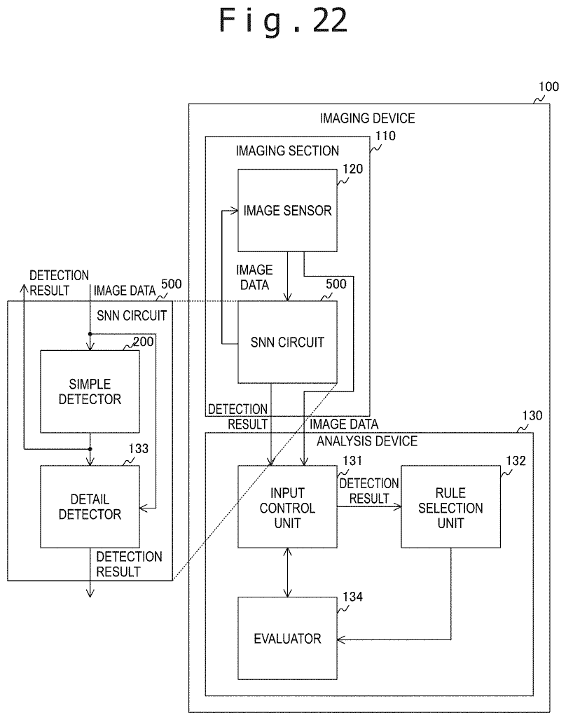

FIG. 22 is a block diagram illustrating a configuration example of the imaging device 100 according to the fourth embodiment of the present technology. The imaging device 100 according to the fourth embodiment is different from that according to the first embodiment in that the detail detector 133 is further provided in the SNN circuit 500.

As illustrated in FIG. 22, by providing the simple detector 200 and the detail detector 133 in the SNN circuit 500, it is not necessary to dispose the detail detector 133 outside the SNN circuit 500.

The modification of the first embodiment and the third embodiment may be applied to the fourth embodiment.

As described above, according to the fourth embodiment of the present technology, since the simple detector 200 and the detail detector 133 are provided in the SNN circuit 500, it is not necessary to dispose the detail detector 133 outside the SNN circuit 500.

### 5. Fifth Embodiment

In the first embodiment described above, the simple detector 200 is disposed outside the image sensor 120, but the simple detector 200 may be disposed inside the image sensor 120. The imaging device 100 according to the fifth embodiment is different from that according to the first embodiment in that the simple detector 200 is disposed in the image sensor 120.

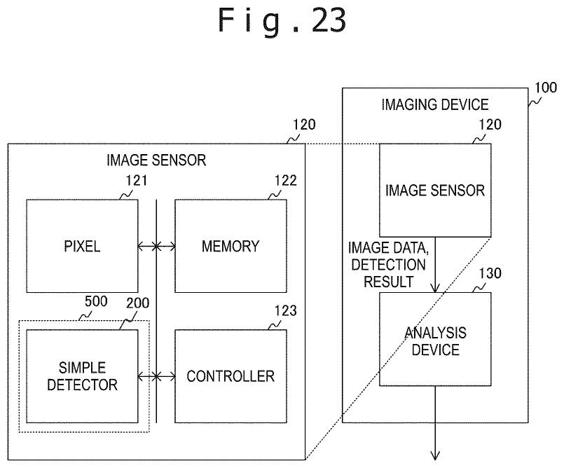

FIG. 23 is a block diagram illustrating a configuration example of the imaging device 100 according to the fifth embodiment of the present technology. The imaging device 100 according to the fifth embodiment is different from that according to the first embodiment in that the simple detector 200 is disposed in the image sensor 120.

The image sensor 120 includes, for example, a pixel array section 121, a memory 122, the simple detector 200, and a controller 123. The simple detector 200 is mounted in the SNN circuit 500.

A plurality of pixels each of which generates a pixel signal are arrayed in the pixel array section 121.

The memory 122 holds various data such as image data. The controller 123 controls the circuits in the image sensor 120.

By providing the simple detector 200 inside the image sensor 120, it is not necessary to dispose the simple detector 200 outside the image sensor 120.

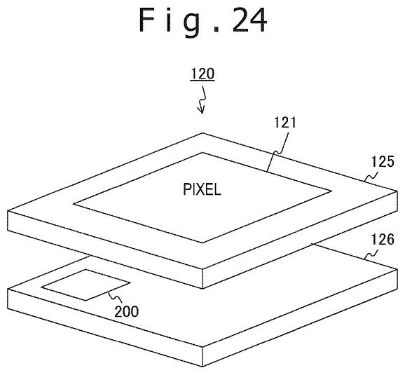

FIG. 24 is a view illustrating an example of a layered structure of the image sensor 120 according to the fifth embodiment of the present technology. The image sensor 120 includes a logic chip 126 and a pixel chip 125 layered on the logic chip 126. These chips are electrically connected by, for example, Cu—Cu bonding. Instead of Cu—Cu bonding, connection may be performed using a via or a bump.

The pixel array section 121 is disposed on the pixel chip 125. The remaining circuits such as the simple detector 200 are disposed on the logic chip 126.

Note that the circuits in the image sensor 120 are disposed on the pixel chip 125 and the logic chip 126, but these circuits may be disposed on a single semiconductor chip.

The modification of the first embodiment and the second, third, and fourth embodiments can be applied to the fifth embodiment.

As described above, according to the fifth embodiment of the present technology, since the simple detector 200 is provided in the image sensor 120, it is not necessary to dispose the simple detector 200 outside the image sensor 120.

### 6. Six Embodiment

In the first embodiment described above, the rule selection unit 132 selects a rule on the basis of a detection result, but in this configuration, an erroneous rule may be selected due to erroneous detection of the simple detector 200 or the like. The imaging device 100 according to the sixth embodiment is different from that according to the first embodiment in that a rule is selected based on a sensor signal from an environmental sensor and a detection result.

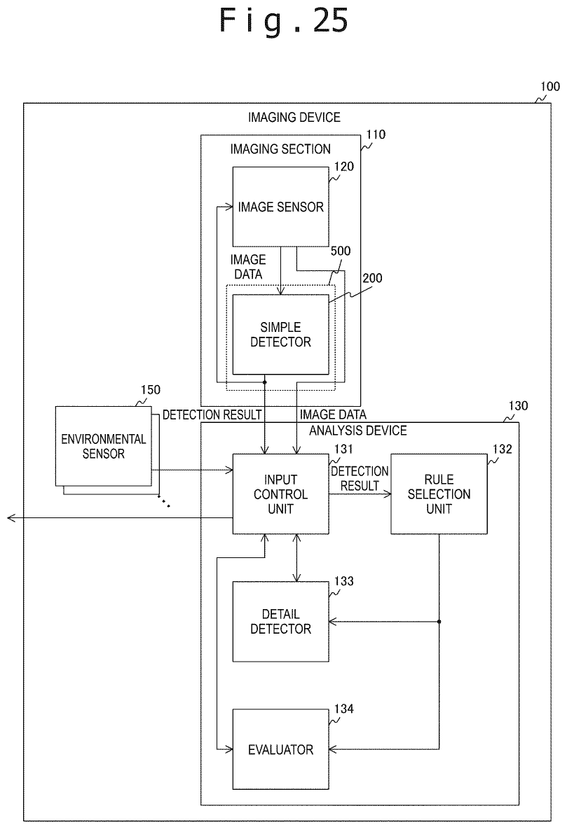

FIG. 25 is a block diagram illustrating a configuration example of the imaging device 100 according to the sixth embodiment of the present technology. The imaging device 100 according to the sixth embodiment is different from that according to the first embodiment in that one or more environmental sensors 150 are provided.

The environmental sensor 150 generates a sensor signal different from image data. For example, a temperature sensor, a humidity sensor, an illuminance sensor, a pressure sensor, an acoustic sensor, or a vibration sensor can be used as the environmental sensor 150. In addition, a proximity sensor, a contact sensor, or an inertial sensor each attached to a measurement target or the periphery of the measurement target can be used as the environmental sensor 150. The sensor signal of the environmental sensor 150 is supplied to the rule selection unit 132 via the input control unit 131.

The rule selection unit 132 selects a rule on the basis of the sensor signal from the environmental sensor 150 and a detection result. For example, even when the simple detector 200 fails in detection although a person has approached, the rule selection unit 132 can detect the person from a sensor signal of the acoustic sensor, the vibration sensor, or the like and select an appropriate rule. This prevents an erroneous rule from being selected when the simple detector 200 performs erroneous detection or detection omission occurs, and makes the system robust.

The modification of the first embodiment and the second, third, fourth, and fifth embodiments can be applied to the sixth embodiment.

As described above, according to the sixth embodiment of the present technology, since the rule selection unit 132 selects a rule on the basis of the sensor signal from the environmental sensor 150 and a detection result, the system can be robust.

### 7. Application Example to Mobile Body

The technology according to the present disclosure (present technology) can be applied to various products. For example, the technology according to the present disclosure may be implemented as a device mounted on any type of mobile bodies such as a vehicle, an electric vehicle, a hybrid electric vehicle, a motorcycle, a bicycle, a personal mobility, an airplane, a drone, a ship, and a robot.

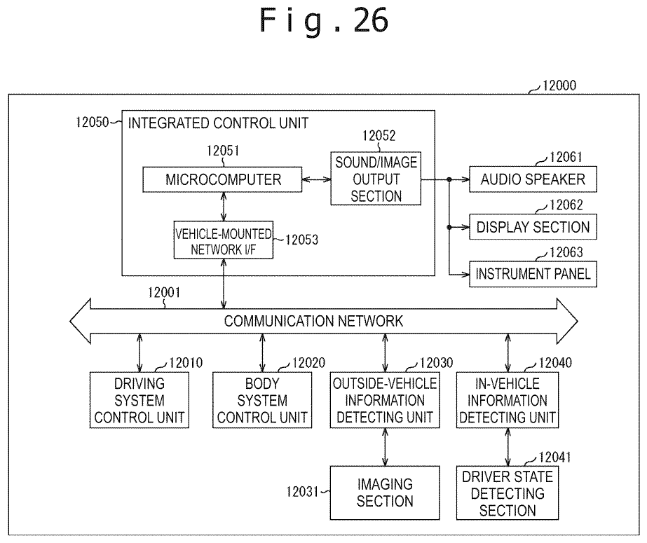

FIG. 26 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 26, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 26, an audio speaker 12061, a display section 12062, and an instrument panel 12063 are illustrated as the output device. The display section 12062 may, for example, include at least one of an on-board display and a head-up display.

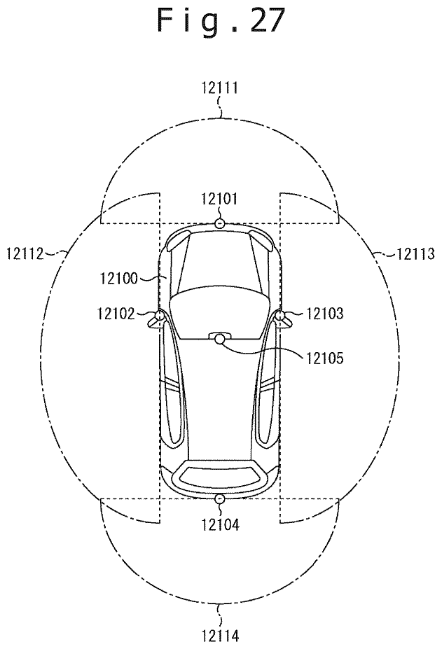

FIG. 27 is a diagram depicting an example of the installation position of the imaging section 12031.

In FIG. 27, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 27 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 among the above-described configurations. Specifically, the imaging device 100 in FIG. 1 can be applied to the imaging section 12031. By applying the technology according to the present disclosure to the imaging section 12031, it is possible to suppress the performance degradation of the system when the sparsity is improved.

Note that the above-described embodiments are examples for embodying the present technology, and the matters according to the embodiments and the matters specifying the invention in the scope of claims have correspondence relationships, respectively. Similarly, the matters specifying the invention in the scope of claims and the matters in the embodiments of the present technology to which the same names are given have correspondence relationships, respectively. However, the present technology is not limited to the embodiments, and can be embodied by applying various modifications to the embodiments without departing from the gist of the present technology.

Note that the effects described in the present specification are merely examples, and are not limited, and other effects may be obtained.

Note that the present technology may also have the following configurations.
(1) An imaging device including a simple detector, in which
the simple detector includes
a predetermined number of output-side neurons each of which generates an output signal on the basis of an input signal from an intermediate layer every time a predetermined unit time elapses, and
a statistic calculation unit that performs, for each of the output-side neurons, a calculation of a statistic of the output signals generated within a predetermined frame period longer than the unit time.
(2) The imaging device according to (1), further including a function calculation unit that outputs a calculation value obtained by inputting each of the statistics to a predetermined function.
(3) The imaging device according to (3), further including a control unit that controls a length of the frame period in accordance with a detection result of the simple detector.
(4) The imaging device according to (3), further including a control unit that controls a threshold value of a neuron in the simple detector in accordance with the detection result of the simple detector.
(5) The imaging device according to any one of (1) to (4), further including an image sensor that generates image data, in which
the simple detector detects a predetermined detection target from the image data by analysis.
(6) The imaging device according to (5), further including
a detail detector that detects a predetermined detection target from the image data by a more detailed analysis than the simple detector,
an evaluator that generates an evaluation value from the image data by an analysis different from the analysis by the detail detector, and
a rule selection unit that selects a rule for controlling operations of the detail detector and the evaluator, on the basis of a detection result of the simple detector.
(7) The imaging device according to (6), in which the simple detector and the detail detector are disposed in a neural network circuit.
(8) The imaging device according to (6), in which the simple detector, the detail detector, and the evaluator are disposed in a neural network circuit.
(9) The imaging device according to any one of (6) to (8), further including an input control unit that controls an operation of the image sensor on the basis of the detection result of the simple detector.
(10) The imaging device according to any one of (6) to (9), further including an environmental sensor that outputs a sensor signal different from the image data, in which
the rule selection unit selects the rule on the basis of the sensor signal and the detection result of the simple detector.
(11) The imaging device according to any one of (1) to (10), in which the simple detector is disposed in an image sensor that generates image data.
(12) The imaging device according to any one of (1) to (11), in which a neuron in the simple detector is a spiking neuron.
(13) An imaging device including
a difference calculator that performs a calculation of a difference between an additional value of a predetermined number of input signals and a feedback signal,
an integrator that integrates the difference and outputs an integral value,
a limiter that outputs the integral value as an output signal when the integral value is out of a predetermined range,
a comparator that compares the output signal with a predetermined value and supplies a comparison result, and
a feedback unit that converts the comparison result into the feedback signal and feeds back the feedback signal, in which
the difference calculator, the integrator, the limiter, the comparator, and the feedback unit are disposed in at least one of a plurality of neurons in a neural network.
(14) An imaging system including
a simple detector including a predetermined number of output-side neurons each of which generates an output signal on the basis of an input signal from an intermediate layer every time a predetermined unit time elapses, and a statistic calculation unit that performs, for each of the output-side neurons, a calculation of a statistic of the output signals generated within a predetermined frame period longer than the unit time, and
an analysis device that analyzes an image on the basis of a detection result of the simple detector.
(15) A control method of an imaging device including
a procedure in which a predetermined number of output-side neurons each generate an output signal on the basis of an input signal from an intermediate layer every time a predetermined unit time elapses, and
a procedure in which a calculation of a statistic of output signals generated within a predetermined frame period longer than the unit time is performed for each of the output-side neurons.

### REFERENCE SIGNS LIST

100 Imaging device
110, 110-1, 110-2 Imaging section
120 Image sensor
121 Pixel array section
122 Memory
123 Controller
125 Pixel chip
126 Logic chip
130 Analysis device
131 Input control unit
132 Rule selection unit
133 Detail detector
134 Evaluator
140 Control CPU
150 Environmental sensor
200 Simple detector
210 Input layer
211, 212 Convolutional layer
213 Pooling layer
220 Intermediate layer
230 Output layer
231 Output-side neuron
232 Statistic calculation unit
233 Function calculation unit
300 ΔΣ neuron
310 Difference calculator
320 Integrator
330 Limiter
340 Comparator
350 Feedback unit
500 SNN circuit
510 Control unit
560 Input/output interface
570 Multi-core array
580 Router
581 to 585 FIFO memory
586 Arbiter
590 Core
591 Core router
592 Neuron I/O
593 Product-sum unit
594 Work memory
595 Membrane potential memory
596 LIF unit
600 Processor
12031 Imaging section

1. An imaging device comprising a simple detector, wherein
the simple detector includes
a predetermined number of output-side neurons each configured to generate an output signal on the basis of an input signal from an intermediate layer every time a predetermined unit time elapses; and
a statistic calculation unit configured to perform, for each of the output-side neurons, a calculation of a statistic of the output signals generated within a predetermined frame period longer than the unit time.

2. The imaging device according to claim 1, further comprising a function calculation unit configured to output a calculation value obtained by inputting each of the statistics to a predetermined function.

3. The imaging device according to claim 3, further comprising a control unit configured to control a length of the frame period in accordance with a detection result of the simple detector.

4. The imaging device according to claim 3, further comprising a control unit configured to control a threshold value of a neuron in the simple detector in accordance with the detection result of the simple detector.

5. The imaging device according to claim 1, further comprising an image sensor configured to generate image data, wherein
the simple detector detects a predetermined detection target from the image data by analysis.

6. The imaging device according to claim 5, further comprising:
a detail detector configured to detect a predetermined detection target from the image data by a more detailed analysis than the simple detector;
an evaluator configured to generate an evaluation value from the image data by an analysis different from the analysis by the detail detector; and
a rule selection unit configured to select a rule for controlling operations of the detail detector and the evaluator, on the basis of a detection result of the simple detector.

7. The imaging device according to claim 6, wherein the simple detector and the detail detector are disposed in a neural network circuit.

8. The imaging device according to claim 6, wherein the simple detector, the detail detector, and the evaluator are disposed in a neural network circuit.

9. The imaging device according to claim 6, further comprising an input control unit configured to control an operation of the image sensor on the basis of the detection result of the simple detector.

10. The imaging device according to claim 6, further comprising an environmental sensor configured to output a sensor signal different from the image data, wherein
the rule selection unit selects the rule on the basis of the sensor signal and the detection result of the simple detector.

11. The imaging device according to claim 1, wherein the simple detector is disposed in an image sensor configured to generate image data.

12. The imaging device according to claim 1, wherein a neuron in the simple detector is a spiking neuron.

13. An imaging device comprising:
a difference calculator configured to perform a calculation of a difference between an additional value of a predetermined number of input signals and a feedback signal;
an integrator configured to integrate the difference and output an integral value;
a limiter configured to output the integral value as an output signal when the integral value is out of a predetermined range;
a comparator configured to compare the output signal with a predetermined value and supply a comparison result; and
a feedback unit configured to convert the comparison result into the feedback signal and feed back the feedback signal, wherein the difference calculator, the integrator, the limiter, the comparator, and the feedback unit are disposed in at least one of a plurality of neurons in a neural network.

14. An imaging system comprising:
a simple detector including
a predetermined number of output-side neurons each configured to generate an output signal on the basis of an input signal from an intermediate layer every time a predetermined unit time elapses, and
a statistic calculation unit configured to perform, for each of the output-side neurons, a calculation of a statistic of the output signals generated within a predetermined frame period longer than the unit time; and
an analysis device configured to analyze an image on the basis of a detection result of the simple detector.

15. A control method of an imaging device, comprising:
a procedure in which a predetermined number of output-side neurons each generate an output signal on the basis of an input signal from an intermediate layer every time a predetermined unit time elapses; and
a procedure in which a calculation of a statistic of output signals generated within a predetermined frame period longer than the unit time is performed for each of the output-side ne
